(19) United States
(12) Patent Application Publication
(10) Pub. No.: US 2017/0105539 A1
(43) Pub. Date: Apr. 20, 2017

(54) LESS TOXIC MATTRESS

(71) Applicant: BJ2, LLC, University Heights, OH (US)

(72) Inventor: Barry Cik, University Heights, OH (US)

(21) Appl. No.: 15/391,536

(22) Filed: Dec. 27, 2016

Related U.S. Application Data
(63) Continuation-in-part of application No. 15/042,167, filed on Feb. 12, 2016.
Application No. 15/042,167 is a continuation of application No. 12/044,456, filed on Mar. 7, 2008, now Pat. No. 9,259,096.
(60) Provisional application No. 60/939,418, filed on May 22, 2007.
(60) Provisional application No. 60/893,939, filed on Mar. 9, 2007.

(51) Int. Cl. A47C 27/00; A47C 31/00; A47D 15/00; B32B 27/36; B32B 5/32; B32B 27/08; B32B 27/06; B32B 27/32; A47C 27/04; B32B 5/18

(52) U.S. Cl. CPC A47C 27/002; A47C 27/04; A47C 31/001; A47D 15/001; A47C 31/007; B32B 5/18; B32B 5/32; B32B 27/08; B32B 27/065; B32B 27/32; B32B 27/36; B32B 2266/025; B32B 2307/3065

(57) ABSTRACT

A mattress and method of constructing the mattress having a reduced toxicity has a cover or an outermost layer including food grade polyethylene. Also, the outer layer of the mattress can also be constructed from a material selected from the same group of materials. Food grade polyethylene films are less toxic materials which reduce adverse human health effects due to the exposure to potentially harmful chemicals used in the mattress construction.

### CROSS-REFERENCE TO RELATED APPLICATIONS

This application is a continuation-in-part of U.S. patent application Ser. No. 15/042,167, filed Feb. 12, 2016, which is a continuation of U.S. patent application Ser. No. 12/044,456, filed Mar. 7, 2008, now U.S. Pat. No. 9,259,096, issued Feb. 16, 2016, which claims the benefit under 35 U.S.C. §119(e) to U.S. Provisional Patent Application Ser. Nos. 60/939,418, filed May 22, 2007, and 60/893,939, filed Mar. 9, 2007; the disclosures of which are incorporated herein by reference in their entirety.

### FIELD OF THE INVENTION

The present invention relates to mattress materials that significantly reduce any potential human harm due to exposure to the mattress materials. More specifically, the present invention relates to a method for processing and constructing mattress materials to reduce the toxicity of a mattress in order to reduce the risk of adverse human allergic reaction or exposure to potentially harmful chemicals due to the materials or material impurities used in the mattress construction.

### BACKGROUND OF THE INVENTION

There are various mattress constructions that use materials that, by themselves or due to some material or chemical impurities, can cause or aggravate human allergenic reactions and/or can result in other potentially harmful exposures. For example, materials that incorporate polyurethanes, polyvinyl chlorides, polystyrenes, or polycarbonates can contain hazardous substances that are potentially harmful to human health, safety, and the environment.

A mattress cover is typically the outermost layer or combination of layers in the assembled mattress. The mattress cover, or outermost layer, functions to isolate the mattress from the human body. That is, the outermost layer is primarily used to provide a barrier between the mattress and the person, limiting deterioration of the mattress and above all preventing the passage of potentially irritating or harmful substances, bacteria or parasites from the mattress to the person.

The mattress typically contains dusty material (deriving from the natural wool or erosion of the foam rubber), which can pass through the surface of the mattress and may irritate the skin, lungs or other sensitive areas of a human. Furthermore, as time passes, the surface layers of the mattress are subject to deterioration and/or contamination with bacteria and parasites. Being that the outermost layer can be in close proximity to, or in contact with a user's skin, eyes, mouth, and nostrils, it is preferable not to allow any water soluble or volatile organic solvent, chemical contaminant or material impurity in the outermost layer or in the mattress itself. If any of these materials were to be adsorbed by the skin, mouth, and the eyes, and inhaled into the mucous membranes and the lungs, they may cause a negative effect on the user's health.

For example, the deteriorated and/or contaminated surface of the outermost layer can cause skin irritation and/or other types of allergic or adverse reactions. More specifically, there are risks that the movement of air over and through the outermost layer can transport chemical impurities or chemical contaminants arising from the mattress materials to the sensitive skin or lungs of infants, asthmatics or hyper-allergenic humans.

The typical exposure to a mattress used in bedding and furniture can range from about 6 hours per day for adults to as high as 18 hours or more per day for infants. Due to the typically high amount of exposure to mattress materials, there is a need for a less toxic material construction of the outermost layer as well as the mattress itself.

The outermost layers produced so far only partly satisfy the above requirements. For example, the barrier effect is obtained by considerably increasing the thickness of the sheet, adding a membrane, or using certain plastic, rubber or latex to provide the necessary effect. In some cases, fabrics have been treated with an antibacterial that minimizes the growth of bacteria and mold. However, these chemicals can leach out of the substrate and become less effective. In addition, some antimicrobials, such as Triclosan (5-chloro-2-(2,4-dichlorophenoxy)phenol), commonly used in a variety of consumer goods including fabrics, have been linked to hormone regulation in animals (U.S. FDA/UCM205999). There is therefore a need for outermost layer sheets that are free from the above limitations that can provide an effective barrier that is biocompatible and comfortable for the user.

### SUMMARY OF THE INVENTION

The present invention is directed to a less toxic mattress cover, or outermost layer. The outermost layer can be constructed from food grade plastics that do not contain dyes or other materials that may be harmful to humans.

The U.S. Food & Drug Administration (FDA) sets standards for plastic resins used in food packaging to be of greater purity than plastics used for non-food packaging. This is commonly referred to as food grade plastic. Food grade plastics do not contain dyes or other materials that may be harmful to humans. In addition, food grade plastics are manufactured in facilities that are ISO 9000 certified and practices good manufacturing processes.

It has been found that outermost layers made from food grade Low Density Polyethylene (LDPE), which includes Linear Low Density Polyethylene (LLDPE) or a blend of LDPE and LLDPE and its copolymers or homopolymers that meet FDA standards, offer a very low level of toxicity and can eliminate or reduce adverse human health effects due to the mattress construction materials or their impurities, and especially when used as the outermost layer material. Even when food grade LLDPE or a blend of LDPE and LLDPE are used for food containers, they are not known to leach any chemicals, chemical impurities or contaminants that are suspected of causing adverse human health effects. The outermost layer may also include food grade Polylactic Acid (PLA) and the PLA can be blended with food grade LDPE, food grade LLDPE, or combinations thereof.

It is also within the terms of the present invention to use starch, such as starch sourced from potatoes or corn, or biopolymers, such as PLA, naturally occurring zein, the principle protein of corn, or poly-3-hydroxybutyrate based films and laminates to maximize the renewable and recyclable materials content.

It is also within the terms of the present invention to construct a mattress using organically grown cotton batting in order to eliminate any possible agricultural pesticide or chemical fertilizer contamination. This organic cotton batting can be treated with ozone gas or other sanitizing processes to clean, oxidize, and remove other possible hazardous processing substances commonly used in textile manufacturing.

According to an example embodiment of the present invention, there is disclosed a less toxic mattress that has a reduced level of toxicity. Without limitation, the toxicity of the mattress in whole or any individual mattress layers or combination thereof can be reduced to levels that are relatively non-toxic or non-toxic, for example, meeting the UL GREENGUARD Gold Standard. The less toxic mattress includes an outer layer of the mattress which can include food grade LDPE, food grade LLDPE, PLA, or mixtures thereof. A next lower layer of the mattress can be encompassed by the outer layer. An inner cushioning layer of the mattress can be encompassed by the outer layer and the next lower layer of the mattress. An innermost component of the mattress can be embedded within the inner cushioning layer. The inner cushioning layer and innermost components can include the inner material as disclosed herein. The layers can also be constructed in a different order. For example, the next lower layer could include the less toxic material, while the outermost layer is something else.

Further according to another example embodiment of the present invention, the less toxic mattress includes a less toxic mattress cover or outermost layer for covering the outer layer of the mattress. The mattress cover or outermost layer can be constructed from materials including food grade polyethylene including polyethylene derived from petrochemicals or natural feedstocks (i.e., cane sugar), PLA polymers or films or a combination of both.

Still further according to another example embodiment of the present invention, the mattress cover or outermost layer can be constructed of, or further contain a PLA film including homopolymers and copolymers of lactic acid containing at least 50 mole % lactic acid units and mixtures thereof having a number average molecular weight of 3,000-200,000 g/mol.

Moreover, according to the present invention, the mattress cover or outermost layer is constructed from a film made of food grade polyethylene (LDPE and/or LLDPE) and/or PLA which has been FDA classified as Generally Recognized as Safe (GRAS) or a combination of polyethylene and PLA.

According to another example embodiment of the present invention, the polyethylene included in the utermost layer can be a film that has a density of 0.85 to 1.00 grams per cubic centimeter (g/cc); a maximum extractable fraction (expressed as percent by weight of the polymer) in n-hexane at specified temperatures is 5.5% at 50° C.); and a maximum extractable fraction (expressed as percent by weight of the polymer) in xylenes at specified temperatures is 11.3% at 25° C.

According to another example embodiment of the present invention, the less toxic mattress includes an outer layer. The outer layer can be constructed from materials including polyethylene, PLA polymers or films and combinations thereof.

According to another example embodiment of the present invention, the outer layer of the mattress can be constructed of, or further contain PLA including homopolymers and copolymers of lactic acid containing at least 50 mole % lactic acid units and mixtures thereof having a number average molecular weight of 3,000-200,000 g/mol.

In addition, the outer layer of the mattress can be constructed of a food grade polymer of PLA which has been FDA classified as Generally Recognized as Safe (GRAS) and/or food grade LDPE and/or LLDPE that meets FDA guidelines.

According to another example embodiment of the present invention, the polyethylene included in the outer layer of the mattress has a density is 0.85 to 1.00 g/cc; a maximum extractable fraction (expressed as percent by weight of the polymer) in n-hexane at specified temperatures is 5.5% at 50° C.; and a maximum extractable fraction (expressed as percent by weight of the polymer) in xylenes at specified temperatures is 11.3% at 25° C.

According to another example embodiment of the present invention, the outer layer of the mattress can be heat fused to a substrate within the mattress so as to provide improved tensile strength and tear resistance to the outer layer of the mattress. The fabric substrate can be constructed of materials including cotton, organic cotton, polyester, polypropylene etc. or combinations thereof.

According to another example embodiment of the present invention, the next lower layer of the mattress can include a fabric flame barrier, which acts like a flame retardant instead of toxic halogenated flame retardants that are commonly used.

According to another example embodiment of the present invention, the inner cushioning layer of the mattress, which provides vibration dampening, insulation and cushioning, is constructed of a material selected from the group consisting of organic cotton batting, food grade polyethylene, (LDPE and/or LLDPE) and/or food grade PLA polymer or foam, or latex.

According to another example embodiment of the present invention, the innermost component of the mattress is constructed of a support material that gives the less toxic mattress the necessary strength, maintains the desired shape of the mattress, provides the majority of the cushioning requirements and provides the required weight support.

According to another example embodiment of the present invention, the mattress cover or outermost layer and the outer layer of the mattress can be constructed of a material made from starch. This may include starch sourced from potatoes or corn, a biopolymer, such as PLA, naturally occurring zein, or poly-3-hydroxybutyrate based films and laminates to maximize the renewable and recyclable materials content.

According to another example embodiment of the present invention, the mattress cover or outermost layer made from food grade polyethylene, (LDPE and LLDPE) can be in close proximity to or in contact with a user's skin. The mattress may also be appropriately sized to fit a basinet, crib, cradle, or bed.

According to another example embodiment of the present invention, there is also disclosed a method for constructing a mattress with reduced toxicity. The method can include the steps of (a) forming a food grade Low Density Polyethylene (LDPE) and/or Linear Low Density Polyethylene (LLDPE) cover or outermost layer; (b) forming an outer layer contacting the food grade LDPE and LLDPE; and (c) forming an inner material contacting the outer material. The inner material can include an inner cushioning layer that contains innermost components that are part of or embedded within the inner cushioning layer.

According to another example embodiment of the present invention, the outer layer of the mattress is covered with a mattress cover or outermost layer constructed from a material including a polyethylene film and/or a PLA film or a combination of both.

According to another example embodiment of the present invention, the mattress cover or outermost layer is constructed of a film of a food grade polymer of PLA, which has been FDA classified as Generally Recognized as Safe (GRAS), and/or a food grade polyethylene such as LDPE or LLDPE.

According to another example embodiment of the present invention, the outer layer of the mattress is heat fused to a substrate within the mattress so as to provide improved tensile strength and tear resistance to the outer layer of the mattress.

According to another example embodiment of the present invention, the next lower layer of the mattress can be constructed of a fabric flame barrier, which acts as a flame retardant rather than the toxic halogenated flame retardants commonly used.

According to another example embodiment of the present invention, the outermost layer and the outer layer of the mattress is constructed of a material made from starch. The starch may be sourced from potatoes or corn, a biopolymer, such as PLA, naturally occurring zein, or poly-3-hydroxybutyrate based films and laminates to maximize the renewable and recyclable materials content.

According to another example embodiment of the present invention, the mattress cover or outermost layer including food grade LDPE and LLDPE can be in close proximity to, or in contact with a user's skin. The mattress may also be appropriately sized to fit a basinet, crib, cradle, or bed.

### BRIEF DESCRIPTION OF THE DRAWINGS

Advantages of the present invention may become apparent to those skilled in the art with the benefit of the following detailed description and upon reference to the accompanying drawings.

FIG. 1 is an illustration of a mattress in one example embodiment of the present invention.

FIG. 2A is an illustration of a mattress in one example embodiment of the present invention.

FIG. 2B is an illustration of a mattress in one example embodiment of the present invention.

FIG. 2C is an illustration of a mattress in one example embodiment of the present invention.

FIG. 2D is an illustration of a mattress in one example embodiment of the present invention.

While the invention is susceptible to various modifications and alternative forms, specific embodiments thereof are shown by way of example in the drawings. The drawings may not be to scale.

### DETAILED DESCRIPTION OF THE INVENTION

In the description that follows, numerous details are set forth in order to provide a thorough understanding of the present invention. It will be appreciated by those skilled in the art that variations of these specific details are possible while still achieving the results of the present invention. Well-known processing steps and materials are generally not described in detail in order to avoid unnecessarily obfuscating the description of the present invention.

Throughout the descriptions set forth in this disclosure, lowercase numbers or letters may be used, instead of subscripts. For example V_{g} could be written Vg. Generally, lowercase is preferred to maintain uniform font size. Regarding the use of subscripts throughout the text of this document, sometimes a character (letter or numeral) is written as a subscript—smaller, and lower than the character (typically a letter) preceding it, such as “Vs” (source voltage) or “H₂O” (water). For consistency of font size, such acronyms may be written in regular font, without subscripting, using uppercase and lowercase—for example “Vs” and “H₂O”. Materials (e.g., silicon dioxide) may be referred to by their formal and/or common names, as well as by their chemical formula. Regarding chemical formulas, numbers may be presented in normal font rather than as subscripts. For example, silicon dioxide may be referred to simply as “oxide”, chemical formula SiO₂. For example, silicon nitride (stoichiometrically Si₃N₄, often abbreviated as “SiN”) may be referred to simply as “nitride”.

In the description that follows, the dimensions should not be interpreted as limiting. They are included to provide a sense of proportion. Generally speaking, it is the relationship between various elements, where they are located, their contrasting compositions, and sometimes their relative sizes that is of significance.

According to the present invention, there is described materials and a process for reducing the toxicity of mattress covers or outermost layers and mattress construction so as to reduce the risk of undesirable human health effects that may be caused by harmful exposures to mattress construction materials or their impurities. In a non-limiting aspect, the cover and outermost layer of the mattress can be the same layers of the mattress described. In one instance, a mattress cover can be removable from the mattress and in another instance the outermost layer can be integral with the mattress.

A mattress cover or outermost layer, according to the present invention, is constructed of a food grade polymer, Polylactic Acid (PLA) which has been FDA classified as Generally Recognized as Safe (GRAS), and/or a food grade Low Density Polyethylene (LDPE) or Linear Low Density Polyethylene (LLDPE), or a combination of a polyethyelene with PLA that meets either of these FDA guidelines: 177.1520, 21 CFR Ch. I (Apr. 1, 2003 Edition) Olefin Polymers:

Section 2.1, Page 281: Polyethylene for use in articles that contact food except for articles used for packing or holding food during cooking. The polyethylene film meets this FDA specification:
1. Density is 0.85 to 1.00 grams per cubic centimeter (g/cc).
2. Maximum extractable fraction (expressed as percent by weight of the polymer) in N-Hexane at specified temperatures is 5.5% at 50 Degrees Centigrade (Deg C).
3. Maximum extractable fraction (expressed as percent by weight of the polymer) in xylene at specified temperatures is 11.3% at 25 Deg C.

### OR

Section 2.3, Page 281: Polyethylene for use only as component of food-contact coatings at levels up to and including 50 percent by weight of any mixture employed as a food-contact coating. The Polyethylene film meets this FDA specification:
1. Density is 0.85 to 1.00 g/cc.
2. Maximum extractable fraction (expressed as percent by weight of the polymer) in N-Hexane at specified temperatures is 53% at 50° C.
3. Maximum extractable fraction (expressed as percent by weight of the polymer) in xylenes at specified temperatures is 75% at 25° C.

Polyethylene is a polymer consisting of long chains of the monomer ethylene (IUPAC name ethene). Polyethylene is created through polymerization of ethylene in the presence of catalysts such as Ziegler Natta catalysts, i.e. titanium (III) chloride.

LDPE is defined by a density range of 0.850-1.000 g/cc. LDPE has a high degree of short and long chain branching, which means that the chains do not pack into the crystal structure as well. It has therefore less strong intermolecular forces, since the instantaneous-dipole induced-dipole attraction is lower. This results in a lower tensile strength and increased ductility. LDPE is created by free radical polymerization. The high degree of branches with long chains gives molten LDPE unique and desirable flow properties. LDPE has been used for both rigid containers and plastic film applications such as plastic bags and film wrap.

LLDPE is defined by a narrow density range of 0.915-0.925 g/cc. LLDPE is a linear polymer with significant numbers of short branches, made by copolymerization of ethylene with longer-chain olefins. LLDPE differs structurally from LDPE because of the absence of long chain branching. The linearity of LLDPE results from the different manufacturing processes of LLDPE and LDPE. In general, LLDPE is produced at lower temperatures and pressures by copolymerization of ethylene with higher alpha-olefins such as butene, hexene, or octene. The weight or molar percentage of higher alpha-olefins copolymerized ethylene in the LLDPE of the present invention can include 1, 2, 3, 4, 5, 6, 7, 8, 9, 10, 11, 12, 13, 14, 15, 16, 17, 18, 19, 20%, or any range there between. The copolymerization process produces a LLDPE polymer that has a narrower molecular weight distribution than LDPE and in combination with the linear structure, significantly different rheological properties. LLDPE is less shear sensitive because of its narrower molecular weight distribution and shorter chain branching. LLDPE has higher tensile strength than LDPE, and it exhibits higher impact and puncture resistance than LDPE. The non-toxic mattress of the present invention may include LLDPE to improve durability, barrier effect, or waterproofing. In one instance, the LDPE and/or LLPDE helps provide a barrier against water base stains. Lower thickness (gauge) films can be blown when compared with LDPE. LLDPE is used in packaging, particularly film for bags and sheets. LLDPE is used predominantly in film applications due to its toughness, flexibility, and relative transparency.

Without being limited to theory, the mattress of the present invention can also contain any of ultra-high-molecular-weight polyethylene (UHMWPE), ultra-low-molecular-weight polyethylene (ULMWPE or PE-WAX), high-molecular-weight polyethylene (HMWPE), high-density polyethylene (HDPE), high-density cross-linked polyethylene (HDXLPE), cross-linked polyethylene (PEX or XLPE), medium-density polyethylene (HDPE), very-low-density polyethylene (VLDPE), chlorinated polyethylene (CPE), or combinations thereof. The above mentioned polyethyene-based polymers are generally classified by their densities which give them unique structural and physical/chemical properties. As such, any plastic with physical and chemical properties similar to those described herewithin (e.g., low density, less toxicity, etc.) may be incorporated into any one of the disclosed embodiments. Exemplary plastics may include, without limitation, those categorized within Resin Identification Codes 1 (polyethylene terephthelate), 2 (high-density polyethylene), 4 (low-density polyethylene), 5 (polypropylene), 6 (polystyrene), or 7 (other plastics, such as polycarbonate, PLA, and acrylic). In preferred aspects, when these polymers are included in any layer of the mattress they can also be food grade by FDA guidelines, such as those polymers provided in 21 C.F.R. 174-490.

In some aspects, food grade LDPE and LLDPE polymers can be provided together in compositions, materials, layers, or films of the current invention. In one aspect, food grade LDPE and LLDPE are provided and are separated as layered films. The films can be adhered using known equipment and methods (e.g. lamination and the like). In a particular aspect, the food grade LDPE and LLDPE are mixed together in a polymer blend. The weight or molar ratio of LDPE to LLDPE in the polymer blend can be any value from 99:1 to 1:99 or any range or value there between.

Polylactic acid (PLA) or polylactide is a biodegradable, thermoplastic, aliphatic polyester derived from renewable resources such as corn. Polylactide, (O—CH(-CH3)-C(═O)}n, is easily produced in a high molecular weight form through ring-opening polymerization using most commonly a stannous octoate catalyst, but for laboratory demonstrations, tin (II) chloride is often employed.

According to the present invention, suitable polymers for use in constructing the mattress covers or outermost layers and possibly part of the mattress itself are PLA homopolymers and copolymers of lactic acid containing at least 50 mole % lactic acid units and mixtures thereof having a number average molecular weight of 3,000-200,000 g/mol.

Due to the chiral (helical) nature of lactic acid, several distinct forms of polylactide exist: poly-L-lactide (PLLA) is the product resulting from polymerization of L,L-lactide (also known as L-lactide). PLLA has crystallinity around 37%, a glass transition temperature between 50-80° C. and a melting temperature between 173-178° C. The polymerization of a racemic mixture L- and D-lactides leads to the synthesis of poly-DL-lactide (PDLLA), which is not crystalline but amorphous. The physical blend of PDLA and PLLA can be used to widen the polymer's application window.

Copolymers of lactic acid are typically prepared by catalyzed copolymerization of lactide with one or more cyclic esters and/or dimeric cyclic esters. Typical co-monomers include glycolide (1,4-dioxane-2,5-dione), the dimeric cyclic ester of glycolic acid; β-propiolactone, the cyclic ester of 3-hydroxypropanic acid; α,α-dimethyl-β-propiolactone, the cyclic ester of 2,2-dimethyl-3-hydroxypropanic acid; β-butyrolactone, the cyclic ester of 3-hydroxybutyric acid; δ-valerolactone, the cyclic ester of 5-hydroxypentanoic acid; ε-caprolactone, the cyclic ester of 6-hydroxyhexanoic acid, and the lactones of its methyl substituted derivatives, such as 2-methyl-6-hydroxyhexanoic acid, 3-methyl-6-hydroxyhexanoic, 4-methyl-6-hydroxyhexanoic acid, 3,3,5-trimethyl-6-hydroxyhexanoic acid, etc., the cyclic ester of 12-hydroxydodecanoic acid; and 2-p-dioxanone, the cyclic ester of 2-(2-hydroxyethyl)-glycolic acid.

Further, according to the present invention, starch, such as starch sourced from potatoes or corn, biopolymer, such as PLA, naturally occurring zein, or poly-3-hydroxybutyrate based films and laminates are selected to maximize the renewable and recyclable materials content. In some instances, the mattress can further include latex, such as certified organic latex or Forest Stewardship Council certified (FSC) latex.

In another non-limiting embodiment of the present invention, the mattress cover or outermost layer and/or outer layer of the mattress does not include food grade LDPE or food grade LLDPE. In this embodiment, another polymer film such as PLA that has been FDA classified as GRAS can be used in the mattress cover or outermost layer and or outer layer to provide a mattress with less toxicity.

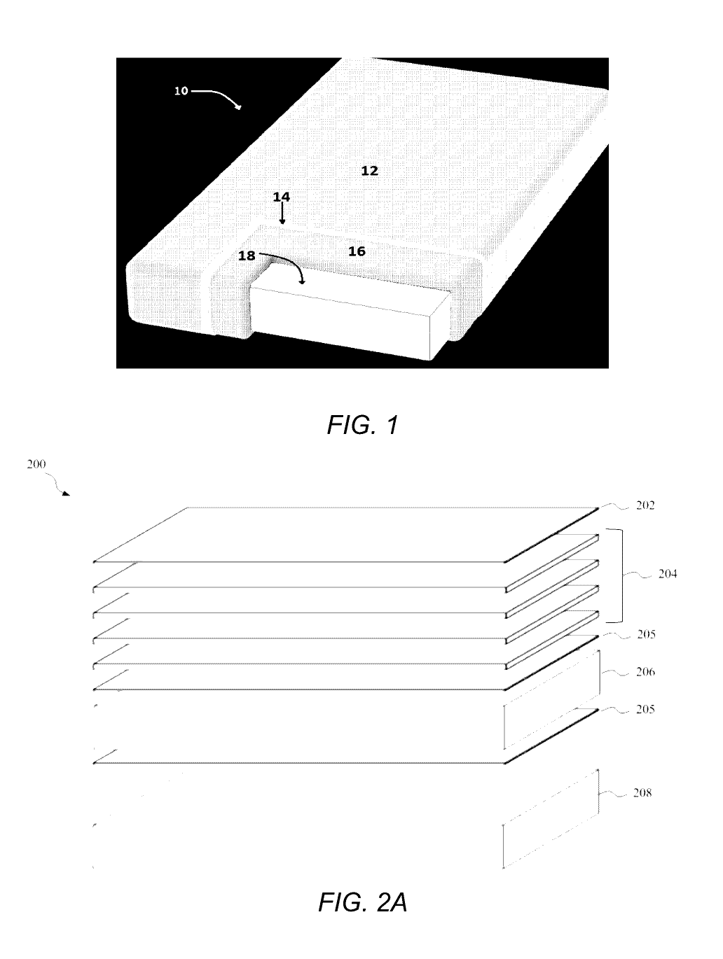

The outer layer 12 of a mattress 10, according to one embodiment of the present invention is shown in FIG. 1. Outer layer 12 can be composed of a polyethylene or PLA film that can be heat fused to organic cotton, cotton or other fabric substrates within the mattress so as to provide improved tensile strength and tear resistance to the outer layer of the mattress.

The next lower layer 14 of the mattress 10, encompassed by the outer layer, can include an industry approved fabric flame barrier which acts as a flame retardant instead of toxic halogenated flame retardants that are commonly used.

The inner cushioning layer 16 of the mattress 10, encompassed by the outer layer and the next lower layer of the mattress can be composed of an organically grown cotton batting or cushioning layer. In one aspect, the inner cushioning layer can be treated with ozone gas to clean, oxidize, and remove other possible contaminant volatiles. Alternately, the inner cushioning layer may be composed of a food grade LDPE or LLDPE or PLA foam. In the foam form, the polymers of the present invention function as packaging, vibration dampening and insulation, or as a material for cushioning.

The innermost component 18 of the mattress 10 embedded within the inner cushioning layer is an innerspring which is constructed from metal or other polymeric support materials that are inherently less toxic than other polymers which provide the same benefits including mattress strength, cushioning, the required weight support and the desired mattress shape. Of course, the layers could be constructed in any suitable order to achieve a less toxic mattress. In addition, more or less layers could be used to form a less toxic mattress, including the use of only three total layers.

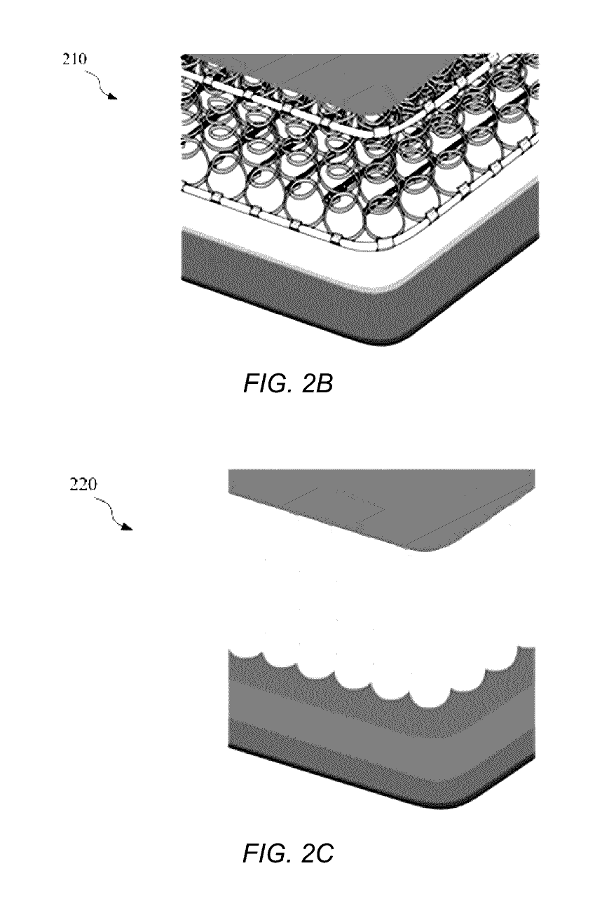

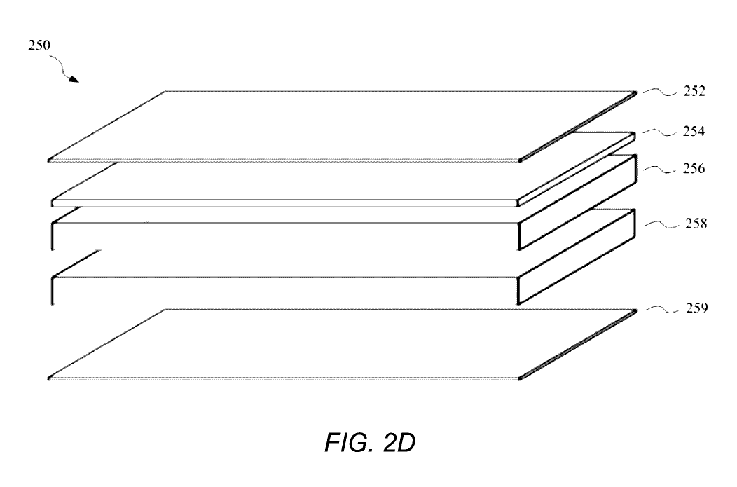

FIG. 2A is an illustration of a mattress 200 in another example embodiment of the present invention. The mattress 200 includes a quilt layer 202 as a top layer. The mattress 200 includes upholstery layers 204 disposed below the quilt layer 202. The mattress 200 includes a base core layer 206 disposed below the upholstery layers 204. The mattress 200 includes a foundation layer 208 disposed below the base core layer 206. It is noted that arrangement of various layers in FIG. 2A is exemplary and is not limiting the disclosure in anyway.

FIG. 2B is an illustration of a mattress 210 in one embodiment of the present invention, in which the mattress includes a spring unit layer. The mattress 210 may include some or all of the various layers discussed in relation to FIG. 1 or FIG. 2 A. It is noted that the arrangement of various layers in FIG. 2B is exemplary and is not limiting the disclosure in anyway.

FIG. 2C is an illustration of a mattress 220 in one embodiment of the present invention, in which the mattress includes a pocketed coil unit. The mattress 220 may include some or all of the various layers discussed in relation to FIG. 1 or FIG. 2 A. It is noted that the arrangement of various layers in FIG. 2C is exemplary and is not limiting the disclosure in anyway.

FIG. 2D is an illustration of a mattress 250 in one embodiment of the present invention. Mattress 250 is one example in which the spring layers (e.g., spring unit or pocketed coil unit) illustrated in either mattress 210 or 220 are replaced with a foam layer(s) (e.g., 256 and/or 258, etc.). The mattress 250 may include a modal or velour fabric layer 252 as a top layer. The mattress 250 may include a polyester wadding layer 254 disposed below the modal or velour fabric layer 252. The mattress 250 may include a memory foam layer 256 disposed below the polyester wadding layer 254. The mattress 250 may include a reflex foam layer 258 disposed below the memory foam layer 256. The mattress 250 may also include a non-slip fabric layer 259 disposed below the reflex foam layer 258. It is noted that arrangement of various layers in FIG. 2D is exemplary and is not limiting the disclosure in anyway.

In FIGS. 2A-2D, an outermost layer can be added to any of the example mattress constructions. The outermost layer can be constructed of a less toxic material, such as food grade polyethylene. Also, any layer of the example mattress constructions could be constructed of a less toxic material, such as food grade polyethylene. Additionally, any suitable number of the layers could be used in combination with a less toxic material, such as food grad polyethylene. And, any order of the layers could be used. For every layer, a less toxic material could be added, for example by melting, onto the top or bottom of the layer.

In one embodiment, the food-grade polyethylene can be the first layer. In one embodiment, the food-grade polyethylene can be melted onto a fabric, so the first layer is the polyethylene and the second layer is the fabric. In another embodiment, the food-grade polyethylene can be melted onto the backside of the fabric, so the fabric becomes the first layer and the polyethylene is the second layer.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components, the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is

1. A mattress comprising:
a food grade Low Density Polyethylene (LDPE) and a food grade Linear Low Density Polyethylene (LLDPE) outermost layer;
an outer material in contact with the food grade LDPE and LLDPE outermost layer; and
an inner material in contact with the outer material.

2. The mattress of claim 1, wherein the LDPE or LLDPE has a density of 0.85 to 1.00 g/cc; a maximum extractable fraction (expressed as percent by weight of the polymer) in n-hexane at specified temperatures is 5.5% at 50° C.; and a maximum extractable fraction (expressed as percent by weight of the polymer) in xylenes at specified temperatures is 11.3% at 25° C.

3. The mattress of claim 1, wherein the LDPE and LLDPE outermost layer is heat fused to the outer material.

4. The mattress of claim 3, wherein the outer material comprises cotton, organic cotton, polyester, recycled polyster, polypropylene, polylactic acid, wool, polyurethane, or combinations thereof.

5. The mattress of claim 1, wherein the mattress comprises an additional layer composed of a fabric flame barrier which acts as a flame retardant.

6. The mattress of claim 1, wherein the inner material comprises a material selected from the group consisting of cotton, organic cotton, LDPE, LLDPE, metal, polyester, recycled polyester, polyurethane, and PLA to provide vibration dampening, insulation, and cushioning.

7. The mattress of claim 1, wherein the inner material comprises a support material that maintains a shape of the mattress.

8. A method to prepare a mattress, comprising the steps of:
(a) forming a food grade LDPE and LLDPE outermost layer;
(b) forming an outer layer contacting the LDPE and LLDPE outermost layer; and
(c) forming an inner material contacting the outer material.

9. The method of claim 8, wherein the LDPE or LLDPE has a density of 0.85 to 1.00 g/cc; a maximum extractable fraction (expressed as percent by weight of the polymer) in n-hexane at specified temperatures is 5.5% at 50° C.; and a maximum extractable fraction (expressed as percent by weight of the polymer) in xylenes at specified temperatures is 11.3% at 25° C.

10. The method of claim 8, wherein the LDPE and LLDPE outermost layer is heat fused to the outer material.

11. The method of claim 10, wherein the outer material comprises organic cotton, cotton, polyester, recycled polyester, polypropylene, PLA, wool, polyurethane, or combinations thereof.

12. The method of claim 8, wherein the mattress comprises an additional layer composed of a fabric flame barrier which acts as a flame retardant.

13. The method of claim 8, wherein the inner material comprises a material selected from the group consisting of cotton, organic cotton, LDPE, LLDPE, metal, polyester, polyurethane, and PLA to providing vibration dampening, insulation, and cushioning.

14. The method of claim 8, wherein the inner material comprises a support material that maintains a shape of the mattress.

15. The mattress of claim 1, wherein the mattress outermost layer can be in close proximity to or in contact with a user's skin.

16. The method of claim 8, wherein the mattress outermost layer can be in close proximity to or in contact with a user's skin.

17. The mattress of claim 1, wherein the mattress is sized to fit a basinet, crib, cradle, or bed.

18. The method of claim 8, wherein the mattress is sized to fit a basinet, crib, cradle, or bed.
